(19) United States
(12) Patent Application Publication
(10) Pub. No.: US 2006/0278176 A1
(43) Pub. Date: Dec. 14, 2006

(54) Baby walking assisting device

(76) Inventors: Yulia Chigirnskaya, Brooklyn, NY (US); Yevgeniy Chigirnskiy, Brooklyn, NY (US)

Correspondence Address: ILYA ZBOROVSKY, 6 SCHOOLHOUSE WAY, DIX HILLS, NY, 11746, US

(21) Appl. No.: 10/897,256

(22) Filed: Jul. 23, 2004

(51) Int. Cl. A62B 35/00

(52) U.S. Cl. 119/770

(57) ABSTRACT

A baby walking assisting device has a support part for supporting a body of a baby and having opening means for passing baby's leg through it so that a baby can walk, and a handle connected with the support part, the handle being substantially loop shaped so as to surround in the position of use a baby's head and extend upwardly above a top of the baby's head, and being composed of substantially rigid material so as to substantially do not change its shape where person holds the handle to walk a baby.

### BACKGROUND OF THE INVENTION

The present invention relates to devices for assisting walking of a baby.

Baby walking assisting device or walkers are designed and produced in many different types. It is believed that it is advisable to further improve the corresponding baby walking device.

### SUMMARY OF THE INVENTION

Accordingly, it is an object of the present invention to provide a baby walking assisting device which is a further improvement of the existing device.

In keeping with these objects and with others which will become apparent hereinafter, one feature of the present invention resides, briefly stated, in a baby walking assisting device, comprising a body supporting part having opening means through which legs of a baby pass so that the baby can walk, and connected with the supporting part so as to hold the supporting part and therefore to hold a baby which is supported in said supporting part, said handle being substantially shaped so as to extend upwardly substantially higher than a top of a head of the body and being composed of a rigid material preventing hurting of the body by said handle.

When the baby walking assisting device is assigned in accordance with the present invention, it further improves assisting a baby to walk.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1 and 2 is a side perspective view and a front perspective view of a baby walking assisting device in accordance with the present invention;

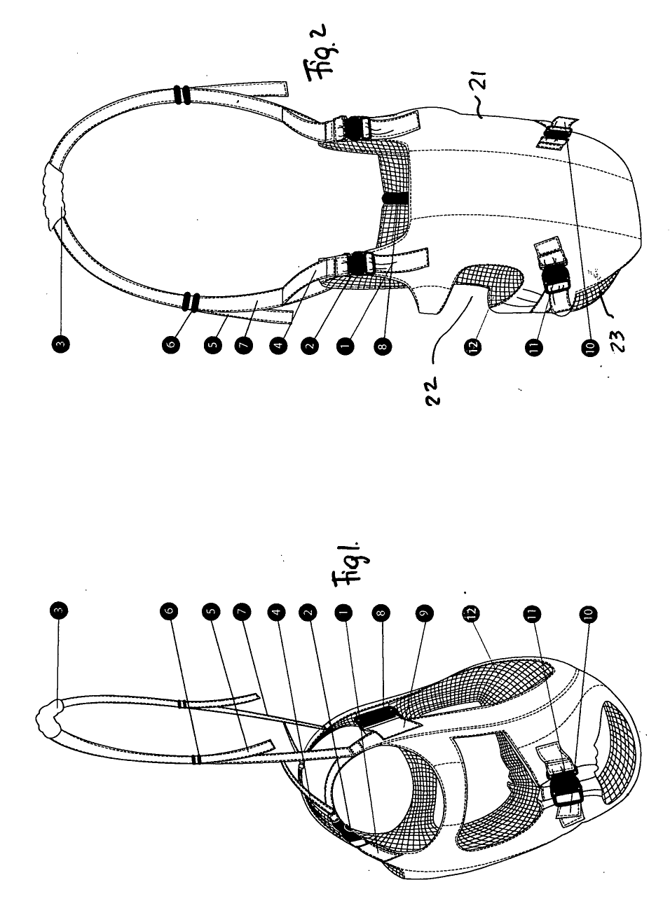

FIGS. 3, 4, and 5 are a back view, a side view and a front view of a baby which is supported by the baby walking assisting device in accordance with the present invention;

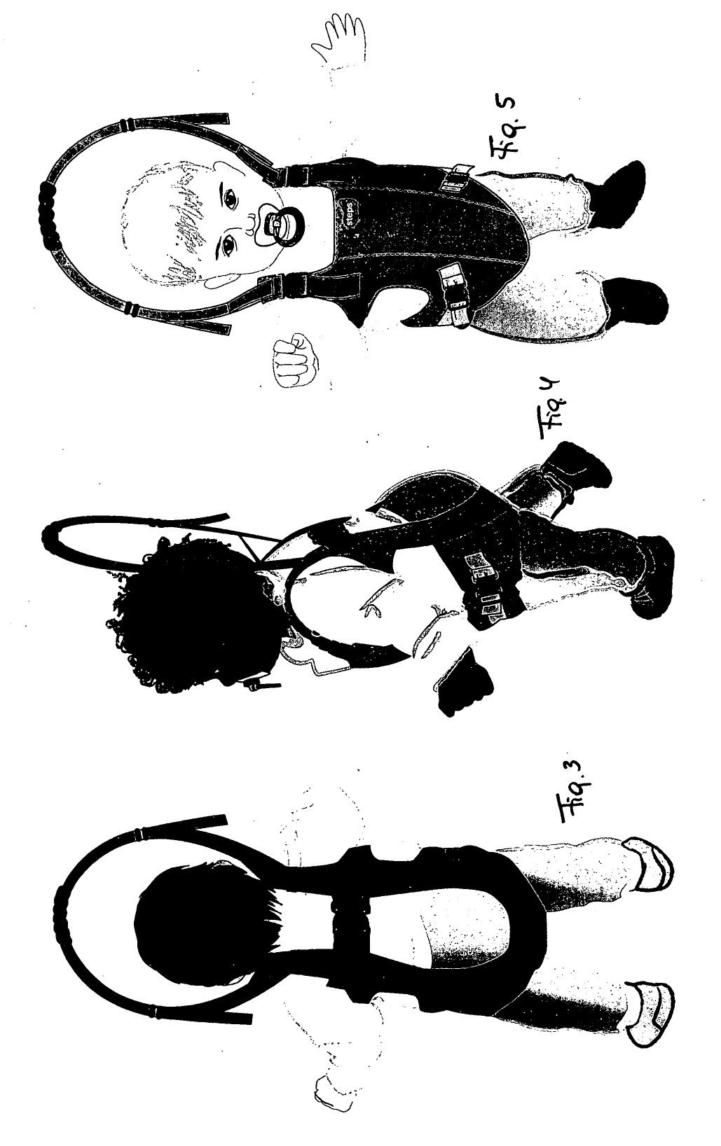

FIG. 6 is a view showing a parent who walks a baby provided with the inventive baby walking supporting device; and

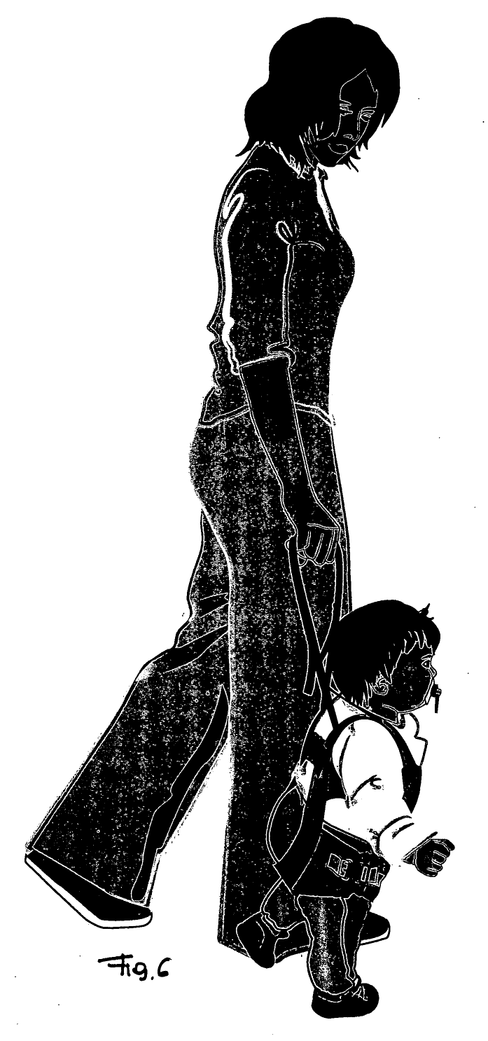

FIG. 7 shows the device with all buckles open.

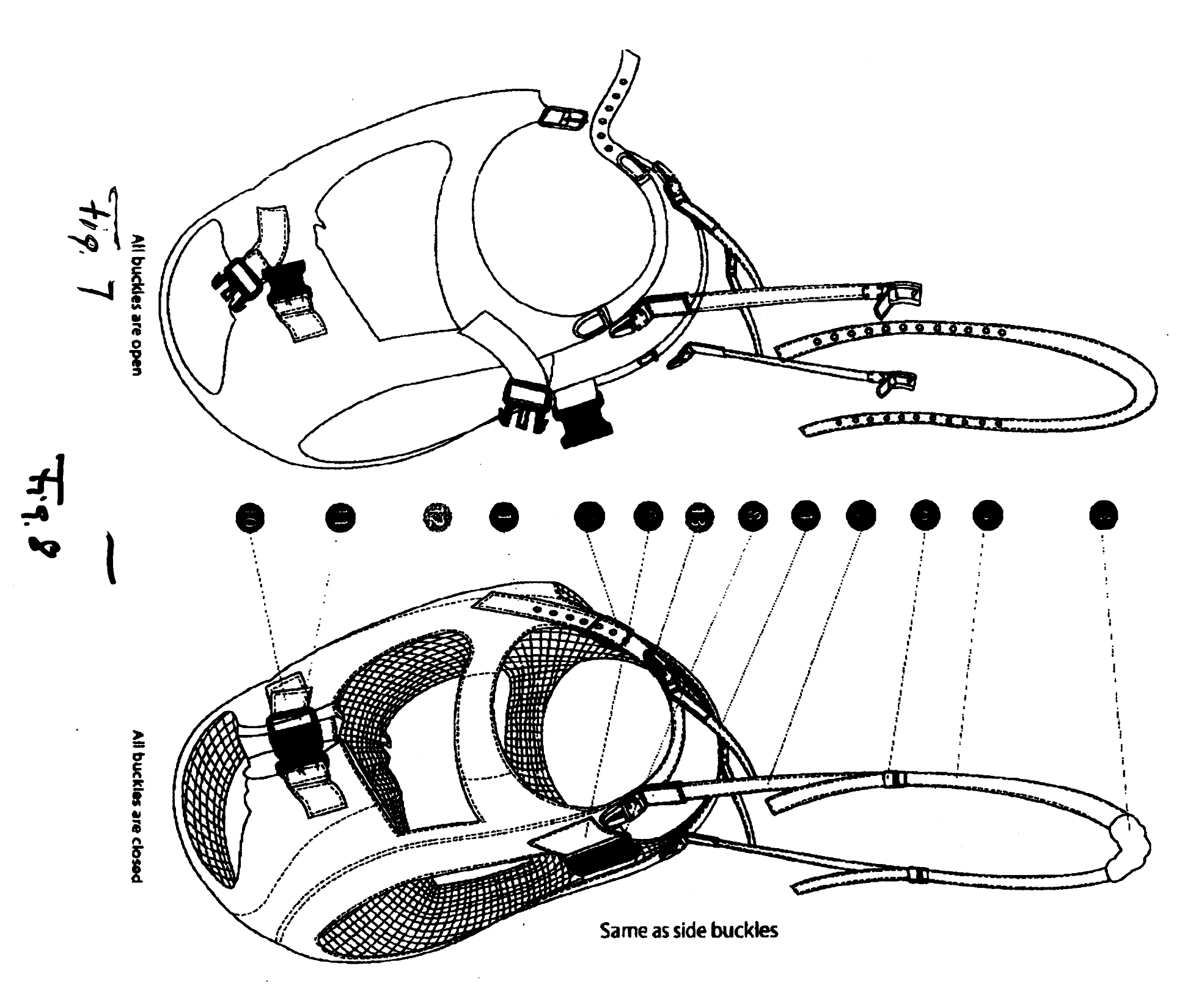

### DESCRIPTION OF THE PREFERRED EMBODIMENTS

A baby walking assisting device has a body supporting part which is identified with reference numeral 21. It has two openings 22 through which arms of a baby can pass, and two openings 23 through which legs of the baby can pass, as shown in the drawings.

The baby support 21 has adjustable front straps 1 which pass through waist strap buckles 2 and can be adjustable depending on the height of the baby. The device further has a handle 3 connected with adjustable handle straps 5 through handle strap double buckles 6. Front strap handle supports 4 are connected with the buckles 2 and also with hard handle straps 7. Each of the buckles 2 can be composed of two parts which are separated from one another in a known manner so as to separate the body support 21 from the front strap handle supports 4 for putting the device on or removing the device from baby.

The device further has an adjustable back support buckle 8, which connects back adjustable straps 9 with one another. Side adjustable straps 10 are connected with one another by a side support buckle 11. Sensitive fabric 12 covers the interior of the support element 21.

The buckles 8 and 11 can also be composed of two parts which are lockable with one another and unlockable. While the buckles 2 serve for adjustment of the device for height of the baby, the buckle 8 serves for adjustment of the device and more particularly of the body support 21 to a size of a baby's chest, and the buckle 11 serves for adjusting the device and more particularly the body support 21 to a size of a lower part of the baby's body.

At least the handle 3 is loop-shaped and composed of a rigid material, for example a rigid plastic. As a result, when a parent assists a baby to walk, the handle 3 substantially does not change its shape, and does not approach the baby's head sideways to squeeze his head. Also, it extends outwardly beyond a top of a baby's head, providing a sufficient space for introducing a parent's hand if the handle is located exactly above the baby's head.

Of course, the handle 3 can be covered with a fabric or another soft material. Also, the straps 4, 5, 7 are hard as well, and can be composed of hard plastic, exactly for the same purpose so as to retain the shape and not to interfere with the baby's head or body, and can be covered with fabric.

It will be understood that each of the elements described above, or two or more together, may also find a useful application in other types of constructions differing from the types described above.

While the invention has been illustrated and described as embodied in baby walking assisting device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A baby walking assisting device, comprising a support part for supporting a body of a baby and having opening means for passing baby's leg through it so that a baby can walk, and a handle connected with said support part, said handle being substantially loop-shaped so as to surround in the position of use a baby's head and extend upwardly above a top of the baby's head, and being composed of a substantially rigid material so as to substantially do not change its shape when a person holds said handle to walk a baby.

2. A baby walking assisting device as defined in claim 1, wherein said handle is composed of an upper handle part and lower handle straps connectable with one another, said upper handle part and said lower handle straps being composed of a substantially rigid material so as to substantially maintain their shape.

3. A baby walking assisting device as defined in claim 2; and further comprising buckle means for connecting said upper part of said handle with said handle straps.

4. A baby walking assisting device as defined in claim 2; and further comprising means for connecting said handle straps with said support part and including adjustable buckle means.

5. A baby walking assisting device as defined in claim 4, wherein said buckle means including two buckles which are composed of two parts which are seperable from one another.

6. A baby walking assisting device as defined in claim 1; and further comprising means for adjusting said support part to a size of a chest of a baby and including back adjustable straps and a back support buckle adjustably connecting said back adjustable straps with one another.

7. A baby walking assisting device as defined in claim 1; and further comprising means for adjusting said support part to a size of a lower part of a baby's body and including side adjustable straps and a side support buckle adjustably connecting said side adjustable straps with one another.
